(19) United States
(12) Patent Application Publication
(10) Pub. No.: US 2026/0073811 A1
(43) Pub. Date: Mar. 12, 2026

(54) LANGUAGE THERAPY WITH MULTILINGUAL AI-AGENT

(71) Applicant: UNIVERSITY OF SOUTH FLORIDA, Tampa, FL (US)

(72) Inventor: Gerald IMAEZUE, Tampa, FL (US)

(21) Appl. No.: 19/326,345

(22) Filed: Sep. 11, 2025

Related U.S. Application Data
(60) Provisional application No. 63/693,426, filed on Sep. 11, 2024.

(51) Int. Cl. G09B 19/04; G10L 15/00; G10L 15/02

(52) U.S. Cl. CPC G09B 19/04; G10L 15/005; G10L 15/02

(57) ABSTRACT

A method for treating a language disorder in a patient includes receiving therapist input specifying a speech target and engagement indicator priority, capturing audio of a speech response to a therapy prompt, and identifying the language of the response using a multilingual language identification model. The method further comprises analyzing the speech response with a language-specific recognition model to extract speech features and classify errors across multiple linguistic and acoustic dimensions. Engagement indicators are extracted and used to compute an engagement score, which, along with the error classifications and speech target, informs a decision model that selects a therapy task. The selected task is presented to the patient, and a subsequent speech response is captured to update error classifications. The decision model is iteratively refined based on therapist input and revised error data, enabling adaptive, personalized therapy progression.

### CROSS-REFERENCE TO RELATED APPLICATIONS

This application claims priority to U.S. Provisional Application No. 63/693,426, filed on Sep. 11, 2024, the entire content of which is hereby incorporated by reference in its entirety.

### BACKGROUND

Speech and language impairments, such as aphasia, can arise from neurological conditions including stroke, traumatic brain injuries, or degenerative diseases. Aphasia is a condition that affects a person's ability to produce and comprehend language, leading to significant challenges in communication. Individuals with aphasia often experience difficulty forming words, constructing sentences, and maintaining fluency in spontaneous speech. These challenges can severely impact personal, social, and professional interactions, reducing the individual's overall quality of life.

Traditional speech therapy for aphasia and related speech impairments typically involves structured exercises conducted under the guidance of a speech-language pathologist. These interventions often rely on modeling and/or external feedback to reinforce correct speech patterns. For example, typical “modeling” approaches can involve a speech-language pathologist providing an example of correct speech production, which the patient then is expected to imitate or repeat. The pathologist listens to the response, manually assesses accuracy of the repeated speech in real time, and provides feedback to the patient accordingly during the appointment.

However, such methods may require frequent clinical visits, access to specialized providers, and ongoing external reinforcement, making them less accessible to individuals with logistical, financial, or geographic barriers to care as well as less helpful in terms of effectuating speech improvement. For example, existing therapy models do not emphasize real-time self-monitoring from the patient (because the patient is accustomed to, and in a position to, rely on the pathologist for monitoring and correction) and do not allow for ongoing training and iterative speech improvement outside of the clinic, which the inventor has established are critical components of effective language rehabilitation.

Therefore, a need exists for improved systems and methods that enable individuals with speech impairments to engage in effective, independent, regular, and adaptive speech therapy without relying solely on external reinforcement. There is further a need for speech therapy systems that leverage technological advancements to provide structured, data-driven, and dynamically adjustable feedback tailored to the user's evolving speech patterns that can be available on-demand and at regular intervals outside of a clinical setting.

### SUMMARY

The following presents a simplified summary of one or more aspects of the present disclosure, to provide a basic understanding of such aspects. This summary is not an extensive overview of all contemplated features of the disclosure and is intended neither to identify key or critical elements of all aspects of the disclosure nor to delineate the scope of any of all aspects of the disclosure. Its purpose is to present some concepts of one or more aspects of the disclosure in a simplified form as a prelude to the more detailed description that is presented later.

Aspects of the described technology may include a method for treating a language disorder in a patient. In some embodiments, the method comprises capturing audio comprising a speech response from the patient in response to a therapy prompt; identifying a language of the speech response using a multilingual language identification model; comparing the speech response to a previous speech response of the patient to determine longitudinal changes; analyzing the speech response using a language-specific recognition model to extract speech features and classify errors across a plurality of error dimensions; computing an engagement score based on engagement indicators extracted from the speech response; applying a decision model to select a subsequent therapy prompt based at least on the error classifications, the engagement score, and a speech target; generating the subsequent prompt based on the selected therapy task and providing it to the patient to elicit a subsequent speech response. Further aspects may include a non-transitory computer-readable medium storing instructions to perform the method and a system configured to execute the method.

These and other aspects of the disclosure will become more fully understood upon a review of the drawings and the detailed description, which follows. Other aspects, features, and embodiments of the present disclosure will become apparent to those skilled in the art, upon reviewing the following description of specific, example embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the disclosure discussed herein. Similarly, while example embodiments may be discussed below as devices, systems, or methods embodiments it should be understood that such example embodiments can be implemented in various devices, systems, and methods.

### BRIEF DESCRIPTION OF THE DRAWINGS

FIG. 1 is a flowchart illustrating a method for adaptive multilingual speech therapy.

FIG. 2 is a flowchart illustrating a system for delivering multilingual therapy using an AI agent.

FIG. 3 is a schematic diagram of a system architecture for implementing the therapy method.

### DETAILED DESCRIPTION

The detailed description set forth below in connection with the appended drawings is intended as a description of various configurations and is not intended to represent the only configurations in which the subject matter described herein may be practiced. The detailed description includes specific details to provide a thorough understanding of various embodiments of the present disclosure. However, it will be apparent to those skilled in the art that the various features, concepts and embodiments described herein may be implemented and practiced without these specific details. In some instances, well-known structures and components are shown in block diagram form to avoid obscuring such concepts.

Aphasia and related language disorders present profound challenges to individuals recovering from stroke, traumatic brain injury, or neurodegenerative conditions. These impairments often manifest as deficits in speech production, comprehension, fluency, and grammatical accuracy, with symptoms varying across languages spoken by the individual. Traditional therapy models rely heavily on clinician-guided exercises and external feedback, limiting accessibility and personalization. The described technology introduces a computer-implemented method for treating aphasia and other language disorders through adaptive, multilingual speech therapy. This method dynamically adjusts therapy tasks based on real-time analysis of patient speech, detected errors, and engagement metrics, enabling personalized treatment across diverse linguistic contexts. By integrating multilingual speech recognition, code-switch detection, and a novel speech and language error matrix, the system identifies phonemic, lexical, and syntactic deficits specific to each user and language. Engagement indicators such as latency, prosody, and speech duration are used to compute a weighted score that informs task selection and delivery modality. Therapy tasks are selected from a multilingual library using a decision policy that incorporates error patterns, engagement scores, and clinician-imposed constraints. The system supports autonomous, clinician-guided, and hybrid deployment modalities, making it suitable for clinical, home-based, and remote environments.

In some embodiments, the system may be deployed via mobile applications, cloud-based platforms, or edge devices, allowing therapy to be delivered in real-time across institutional, outpatient, and telehealth settings. The method begins with profile initialization, capturing user-specific data such as age, diagnosis, and language background, including aphasia type (e.g., Broca's or Wernicke's). Therapy goals are defined by clinicians or inferred from prior speech samples, guiding the selection of targeted tasks. Speech input is captured and analyzed using language-specific models that classify errors and update a personalized error matrix. The system adapts task complexity and delivery format based on ongoing performance, switching between semantic, phonemic, and visual cues as needed. For multilingual users, the system detects language shifts and adjusts therapy accordingly, supporting bilingual and cross-linguistic rehabilitation. Clinicians may override automated decisions, review progress reports, and fine-tune therapy plans via a secure dashboard. The described technology enables scalable, data-driven therapy that evolves with the patient's needs, improving outcomes through continuous feedback and personalization.

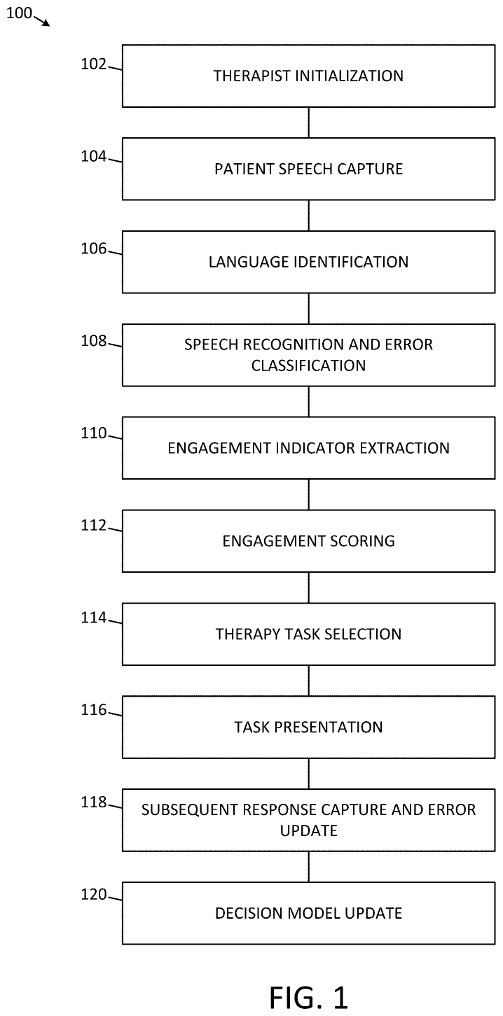

Method 100, as illustrated in FIG. 1, describes a comprehensive, adaptive process for delivering multilingual speech therapy using a dynamic, data-driven framework. The method begins with therapist initialization, wherein clinical input specifying a speech target and engagement indicator priority is received through digital interfaces, voice commands, or remote dashboards, enabling both in-person and teletherapy configurations. Patient speech is captured in response to therapy prompts using microphones embedded in mobile devices, tablets, desktop systems, or dedicated therapy hardware, supporting deployment across clinical, home-based, and hybrid environments. A multilingual language identification model then determines the language of the response, including code-switching detection, enabling therapy in diverse linguistic contexts. Speech recognition and error classification are performed using language-specific models that analyze phonemic, lexical, and syntactic features, with results stored in a multilingual error matrix. Engagement indicators—such as latency, prosody, and vocal effort—are extracted and used to compute a weighted engagement score, which informs subsequent task selection. The system applies a decision model that integrates therapist constraints, error profiles, and engagement metrics to select the next therapy task, which is then presented using multimodal formats including auditory, visual, textual, or interactive GUI elements. The method supports real-time adaptation, allowing task complexity, pacing, and modality to shift based on patient performance and engagement trends. Subsequent responses are captured and analyzed to update the error matrix and refine the decision model, enabling longitudinal tracking and personalized therapy progression. The system may operate in autonomous, clinician-guided, or hybrid modes, and may be deployed via cloud-based services, edge devices, or standalone installations, ensuring scalability across institutional, outpatient, and remote care settings.

The method may include step 102, which comprises receiving therapist input specifying a speech target and an engagement indicator priority. The speech target may correspond to a linguistic objective selected by the therapist, such as phoneme articulation, syntactic structure, semantic fluency, or pragmatic usage. The engagement indicator priority may include one or more behavioral or affective metrics selected by the therapist to guide the system's attention during patient interaction, such as vocal effort, response latency, emotional tone, or consistency of response. The therapist input may be received through any suitable modality, including but not limited to digital interfaces, voice commands, preconfigured templates, or clinician dashboards. In some embodiments, the input may be stored in association with a patient profile and used to initialize subsequent therapy sessions.

Various approaches may be used to perform this step. In one example, the therapist may be physically present with the patient and may provide the input at the beginning of the session. In another example, the therapist may configure the input remotely, prior to the patient's use of the system. The patient may then engage with the system independently, and the system may record the patient's responses and engagement metrics. The therapist may subsequently review the recorded data and adjust the speech target or engagement indicator priority for future sessions.

In some embodiments, therapist input may be received in conjunction with a retrieved user profile. The user profile may include demographic, diagnostic, and linguistic information relevant to therapy planning. For example, the profile may specify the patient's age, primary and secondary languages, aphasia subtype, severity level, prior therapy history, and preferred interface modality. The profile may also include baseline performance metrics, such as average response latency, error types observed in previous sessions, and engagement scores. This information may be used to contextualize the therapist's input and guide the selection of appropriate therapy goals and engagement indicators.

The therapist input may also be used to filter a multilingual therapy task library to produce a goal-specific task set. The task library may include structured exercises such as phoneme repetition, picture description, sentence completion, semantic categorization, and conversational turn-taking tasks. Each task may be annotated with metadata indicating its linguistic focus, difficulty level, modality (e.g., auditory, visual, interactive), and suitability for specific diagnostic profiles. Based on the therapist's specified speech target and engagement indicator priority, the system may select tasks that match the desired therapeutic focus and patient capabilities. In some cases, the therapist may impose constraints on task selection, such as excluding tasks that require fine motor control or prioritizing tasks that elicit spontaneous speech in a target language.

In some embodiments, the speech target may include goals such as improving production of bilabial consonants, reducing phonemic paraphasias, enhancing retrieval of function words, increasing fluency in a selected language, or improving performance in picture description tasks. The engagement indicator priority may include metrics such as speech initiation latency, time on task, prosodic variation, frequency of self-corrections, emotional tone inferred from vocal features, or consistency of response across multiple languages. For multilingual patients, the therapist may specify targets in one or more languages, and the system may track engagement and error patterns across those languages within a unified matrix. These examples are illustrative and not limiting; other linguistic goals and engagement metrics may be specified depending on the patient's diagnosis, therapy goals, language background, and session context. In some cases, the therapist may also configure the system to prioritize specific error types—such as semantic substitutions or morphological omissions—based on prior session data or clinical judgment.

The method may include step 104, which comprises capturing audio comprising a speech response from the patient in response to a therapy prompt. The therapy prompt may be delivered in various formats, including visual stimuli (e.g., images, videos, or animations), textual instructions, or auditory cues, and may elicit different types of responses such as repetition, description, naming, sentence completion, or spontaneous speech. In some embodiments, the prompt may be selected based on a previously specified speech target and may be designed to elicit phonemic, lexical, syntactic, or pragmatic output. Prompts may include questions or stimuli related to personal experiences (e.g., “favorite food,” “first job,” “holiday traditions”), general knowledge, or narrative scenes, and may be configured to vary in complexity depending on the patient's profile and engagement history. The prompt may be part of a structured therapy exercise selected from a goal-specific task set filtered from a multilingual therapy task library.

The speech response may be captured using any suitable input modality, including a microphone embedded in a mobile device, tablet, desktop system, or dedicated therapy hardware. The capture may occur during a live therapy session with a therapist present, or during an asynchronous session initiated by the patient. In some embodiments, the system may support continuous speech capture and may segment the input based on detected pauses, prompt boundaries, or language transitions. The system may also support multiple session modes, including guided exercises, free speech tasks, and conversational simulations. The audio capture may be initiated automatically upon prompt delivery or manually by the patient or therapist, depending on the session configuration.

In further examples, the system may apply real-time monitoring to detect speech onset and offset, enabling dynamic adjustment of recording windows. The captured audio may be processed to remove background noise, normalize volume levels, and extract clean speech segments for downstream analysis. In some embodiments, the system may detect code-switching within the speech response and segment the audio accordingly for language-specific processing. For multilingual patients, the system may capture speech in multiple languages within a single session and associate each segment with the corresponding language identifier. The system may also support capture of non-verbal vocalizations, such as hesitations, fillers, or emotional expressions, which may be relevant for engagement analysis.

The patient may interact with a graphical interface that includes controls for initiating prompt playback, recording responses, and reviewing prior attempts. For example, the interface may include buttons labeled “Listen,” “Record,” and “Playback,” and may automatically transition between prompts based on session flow. In some embodiments, the interface may include visual indicators of recording status, countdown timers, or progress bars to guide the patient through the session. The system may also support accessibility features such as enlarged text, simplified navigation, or voice-guided instructions to accommodate patients with motor or cognitive impairments.

In some implementations, the system may record audiovisual data, capturing both speech and facial expressions. The patient may press and hold a button during speech to indicate active speaking periods, allowing the system to distinguish between intentional pauses and utterance completion. This signaling mechanism may be used to improve segmentation accuracy and reduce false positives in speech detection. The audiovisual data may be stored alongside the audio waveform and may be used to extract additional engagement indicators such as eye movement, facial affect, or head orientation.

The captured audio may be stored in association with session metadata, including a timestamp, prompt identifier, patient identifier, and session context. The audio may be buffered or streamed for real-time analysis, or stored for deferred processing depending on the system configuration. In some cases, the system may also record environmental parameters such as background noise level, device type, and network latency to support downstream signal normalization and error analysis. The audio data may be linked to a session log that includes prompt history, task type, and therapist annotations, enabling comprehensive review and oversight. In some embodiments, the system may generate a transcript of the captured speech using a language-specific recognition model and annotate the transcript with timing, error, and engagement markers.

In some aspects, the system may support multiple capture formats, including raw waveform, compressed audio, and feature vector representations. The captured data may be used to generate phoneme-level, lexical-level, and structural-level alignments between expected and actual output. For example, the system may compare the patient's description of a picture, repetition of a sentence, or naming of an object with the expected corrected output. These alignments may support classification of speech and language errors, including substitution, omission, distortion, and paraphasia. The system may update a speech and language error matrix that tracks error patterns for each phoneme, word, and sentence across multiple languages per user.

In further embodiments, the system may include adaptive timing mechanisms that adjust the duration of recording windows based on patient behavior. For example, if a patient consistently responds within a short latency window, the system may shorten the wait time before transitioning to the next prompt. Conversely, if the patient exhibits delayed responses or frequent hesitations, the system may extend the recording window or provide additional cues. These timing adjustments may be informed by historical session data and may be personalized to each patient's interaction profile.

Additionally, the system may support session-level configuration options that allow therapists to specify capture parameters in advance. These parameters may include maximum recording duration, language-specific filters, expected response types, and error sensitivity thresholds. The configuration may be stored as part of a therapy plan and applied automatically across multiple sessions. In some cases, the system may provide a preview mode that allows therapists to simulate prompt delivery and response capture before initiating a live or asynchronous session.

The method may include step 106, which comprises identifying a language of the speech response using a multilingual language identification model. The speech response may be captured during a therapy exercise and may include structured utterances, spontaneous speech, or extemporaneous responses. In some embodiments, the language identification model may be configured to detect a plurality of spoken languages within a single speech response, including cases where the patient code-switches between languages mid-utterance or across utterances. The model may operate on raw audio, extracted acoustic features, or intermediate representations such as spectrograms, MFCCs (Mel-frequency cepstral coefficients), or phoneme sequences.

In some aspects, the language identification model may comprise a neural architecture trained on multilingual speech corpora, including typical and aphasic speech samples. The model may include convolutional layers for feature extraction, recurrent layers for temporal modeling, and attention mechanisms for weighting salient segments of the input. Architectures may include CNNs, LSTMs, transformer-based models with attention layers, or reservoir computing systems. The model may output a probability distribution over supported languages and may assign a primary language label to each segment of the speech response. In further embodiments, the model may segment the input into language-specific regions and annotate each region with a language tag, confidence score, and temporal boundaries.

The language identification and code-switch handling process serves as a prerequisite for accurate speech recognition and error extraction. The segmented and labeled speech regions produced by this step are routed to language-specific recognition models and error classifiers, including large language models (LLMs) trained on the phonological, lexical, and syntactic structures of each supported language. These classifiers generate alignments between expected and actual outputs and update the multilingual speech and language error matrix described in step 108.

For patients who speak multiple languages, the system may support dynamic identification and segmentation of multilingual input. The model may detect code-switching events and partition the speech response into contiguous segments, each associated with a distinct language. These segments may be routed to language-specific recognition modules, each configured to extract speech features and classify errors in accordance with the phonological, lexical, and syntactic rules of the respective language. For example, a patient may begin a response in Spanish, switch to English mid-sentence, and conclude in French; the system may identify and process each segment independently while preserving the overall session context.

The system may maintain a multilingual speech and language error matrix that tracks phonemic, lexical, and syntactic errors across all languages spoken by the patient. Each entry in the matrix may correspond to a specific error type (e.g., substitution, omission, distortion, paraphasia) for a given phoneme, word, or sentence structure in a particular language. The matrix may be structured as a multi-dimensional representation associating error types with temporal and linguistic metadata, including segment boundaries, language tags, and prompt identifiers. Each detected language may be associated with a language-specific submatrix, which stores error classifications and supports longitudinal tracking of error frequency and persistence. These submatrices may be accessed by the decision model to guide therapy task selection and adaptation.

The language identification step also enables adaptive therapy task selection based on per-language error patterns. For example, if the error matrix indicates persistent lexical omissions in Spanish but improved fluency in English, the system may prioritize Spanish vocabulary tasks while maintaining English conversational prompts. This per-language adaptation is governed by a decision policy that integrates error frequency, engagement metrics, and therapist-imposed constraints.

In some embodiments, the mobile application or clinician dashboard may display a visual indicator of detected language segments, allowing the patient or therapist to review which portions of the response were classified as English, Spanish, or other languages. These indicators may be presented as color-coded overlays on the waveform or transcript, with interactive controls to inspect segment-level metadata such as confidence scores and error annotations. The interface may also allow therapists to override or confirm language labels, providing a mechanism for manual correction or validation.

The system may support multiple deployment configurations. In one example, the language identification model may be embedded in a provider-managed system with manual override capabilities and session-level constraints. In another example, the model may operate as part of an autonomous agent that dynamically adjusts therapy parameters without clinician intervention. The model may be implemented using cloud-based services, edge devices, or hybrid architectures, and may be optimized for latency, accuracy, and robustness to noise and speech variability.

In further embodiments, the system may maintain a language usage history for each patient, including frequency, duration, and context of language use across sessions. This history may be used to refine the language identification model over time, adapt therapy goals, and support longitudinal analysis of multilingual therapy outcomes. The model may be trained using running data accumulation, allowing it to adapt to the patient's evolving speech patterns and language preferences. The language identification step may be performed in real time or as part of a post-processing pipeline, depending on system configuration and session mode. Real-time identification may support dynamic task adaptation, immediate feedback, and interactive session flow, while deferred identification may support detailed analysis, error annotation, and report generation.

In some embodiments, step 108 comprises retrieving a language-specific large language model (LLM) based on the language identified in Step 106, generating expected speech outputs using the retrieved LLM, and classifying errors in the patient's actual speech response by comparing it to the expected outputs. The results of this comparison are used to populate a structured, time-aligned multilingual error matrix, which serves as a central data structure for tracking speech and language errors across therapy sessions.

As described in step 106, the system may apply a language identification model to determine the language of the patient's response. Based on this identification, Step 108 retrieves a corresponding LLM that has been trained or fine-tuned for the identified language. The selected LLM may be configured to generate expected speech outputs by conditioning on both the therapy prompt and the patient's therapy profile, which may include aphasia type, prior error history, and engagement metrics. The expected output represents the idealized or intended speech response that the patient would produce in the absence of impairment.

Following generation of the expected output, the system performs a multi-level comparison between the actual and expected responses. This comparison may be conducted at three linguistic levels: phoneme, lexical, and structural. At the phoneme level, each phoneme in the actual response is compared to its expected counterpart using acoustic similarity metrics, which may include convolutional neural networks (CNNs), fast Fourier transform (FFT) analysis, or dynamic time warping (DTW). At the lexical level, individual words are aligned and compared using transformer-based models capable of capturing semantic, morphological, and contextual deviations. At the structural level, sentence-level constructions are analyzed for syntactic correctness, word order, and grammatical agreement using sequence-to-sequence (Seq2Seq) models, dependency parsers, or other syntactic analysis tools.

The system may classify errors based on the results of these comparisons. Error types may include phonemic substitutions, omissions, and distortions; lexical substitutions, omissions, and paraphasias; and structural errors such as word order violations, agreement mismatches, and sentence fragmentation. Each error may be annotated with a confidence score, a severity rating, and a timestamp, and may be stored in a language-specific submatrix within the broader multilingual error matrix. The multilingual error matrix may be implemented as a tabular data structure that organizes errors by linguistic unit (e.g., phoneme, word, sentence), error type, and language. For example, the matrix may include rows for each phoneme (e.g., /p/, /t/, /k/), each word (e.g., “dog”, “run”), and each sentence structure, with columns indicating substitution, omission, distortion, and paraphasia counts per language.

In further embodiments, the system may compute additional metrics such as Correct Information Units (CIUs), global and local coherence scores, and speech rate. CIUs may be used to quantify the informativeness of the response, coherence scores may assess the logical flow and relevance of utterances, and speech rate may be used to detect fluency disruptions or engagement-related deviations. These metrics may be stored in association with session metadata and used to inform subsequent therapy task selection in Step 114.

The multilingual error matrix supports longitudinal tracking of patient progress and enables detection of cross-linguistic interference, such as transfer errors or false cognate usage. These phenomena may be flagged for therapist review and annotated within the matrix. In some embodiments, the system may visualize error distributions using graphical interfaces such as heatmaps, error timelines, and comparative charts. These visualizations may support export for clinical documentation and research analysis, and may be integrated into dashboards that allow therapists to override or influence adaptive decision policies.

To accommodate diverse clinical workflows, the system may operate in multiple modes. In a provider-driven embodiment, therapists may define expected responses and review classification results via a clinician dashboard. In a user-driven embodiment, patients may receive automated feedback based on real-time classification. In an autonomous embodiment, the system may generate expected outputs, classify errors, and adapt therapy parameters without therapist intervention.

The following table provides an example of such an error matrix, simplified for ease of illustration:

| Error Unit | English | Spanish | Mandarin |
|---|---|---|---|
| /p/Substitution | 2 | 3 | 1 |
| /p/Omission | 1 | 2 | 1 |
| /p/Distortion | 1 | 2 | 1 |
| /p/Paraphasia | 3 | 4 | 2 |
| /t/Substitution | 1 | 2 | 1 |
| /t/Omission | 0 | 1 | 0 |
| /t/Distortion | 1 | 2 | 1 |
| /t/Paraphasia | 2 | 3 | 1 |
| /k/Substitution | 2 | 3 | 1 |
| /k/Omission | 1 | 2 | 1 |
| /k/Distortion | 1 | 2 | 1 |
| /k/Paraphasia | 2 | 3 | 1 |
| Word ‘dog’ Substitution | 3 | 4 | 2 |
| Word ‘dog’ Omission | 1 | 2 | 1 |
| Word ‘dog’ Distortion | 1 | 2 | 1 |
| Word ‘dog’ Paraphasia | 2 | 3 | 2 |
| Word ‘run’ Substitution | 2 | 3 | 2 |
| Word ‘run’ Omission | 1 | 2 | 1 |
| Word ‘run’ Distortion | 1 | 2 | 1 |
| Word ‘run’ Paraphasia | 2 | 3 | 2 |
| Word ‘blue’ Substitution | 1 | 2 | 1 |
| Word ‘blue’ Omission | 0 | 1 | 0 |
| Word ‘blue’ Distortion | 1 | 2 | 1 |
| Word ‘blue’ Paraphasia | 1 | 2 | 1 |
| Sentence Word Order Error | 2 | 3 | 2 |
| Sentence Omission | 1 | 2 | 1 |
| Sentence Agreement Error | 1 | 2 | 1 |
| Sentence Fragmentation | 2 | 3 | 2 |

The process may include step 110, which comprises extracting one or more engagement indicators from a subject's speech response during a therapy session. Engagement indicators may reflect behavioral, temporal, prosodic, and affective characteristics that suggest the subject's level of participation, attention, and responsiveness. These indicators may be derived from raw audio signals, segmented speech units, or multimodal data streams, and may be used to inform subsequent processing steps.

In some embodiments, engagement indicators may include response latency (i.e., the time elapsed between prompt delivery and speech onset), speech duration (i.e., the total time spent speaking), prosodic variation (e.g., pitch, intonation, rhythm), acoustic energy (e.g., vocal effort), and time-on-task metrics. These features may be extracted using signal processing techniques such as short-time Fourier transform (STFT), pitch tracking algorithms, and energy envelope analysis. For example, response latency may be computed by detecting the onset of speech following a prompt using voice activity detection (VAD), while prosodic variation may be quantified using pitch contour analysis and spectral tilt measurements.

In further embodiments, the system may extract higher-order engagement indicators such as emotional tone, consistency of response, and frequency of self-corrections. Emotional tone may be inferred from vocal features such as pitch range, amplitude modulation, and spectral brightness, and may be classified using affective computing models trained on clinical speech data. Consistency of response may be assessed by comparing current speech outputs to prior session data, identifying patterns of repetition, hesitation, or deviation. Self-corrections may be detected by analyzing disfluencies, restarts, and repair sequences within the speech stream.

The system may also support multimodal engagement analysis by incorporating non-verbal cues such as facial affect, eye movement, and head orientation. These cues may be captured using video input and processed using computer vision models to detect gaze direction, facial expressions, and motor engagement. For example, a subject who maintains eye contact with the screen and exhibits expressive facial gestures may be inferred to have high engagement, while a subject who frequently looks away or displays flat affect may be flagged for low engagement. These multimodal indicators may be fused with audio-based features to produce a more comprehensive engagement profile.

In some embodiments, engagement indicators may be extracted separately for each language segment in multilingual therapy sessions. This allows the system to compare engagement levels across languages and adjust therapy focus accordingly. For instance, if a subject exhibits higher engagement during Spanish-language prompts than English-language prompts, the system may prioritize Spanish-language tasks or simplify English-language tasks to improve engagement.

The engagement indicator extraction may be performed in real time or as part of a post-processing pipeline. Real-time extraction may support dynamic task adaptation, immediate feedback, and interactive session flow, while deferred extraction may enable detailed analysis, report generation, and therapist review. In some configurations, the system may visualize engagement indicators using graphical interfaces, such as heatmaps, trend lines, and session summaries. These visualizations may be accessible via a clinician dashboard and may support manual override, annotation, and intervention.

In further embodiments, the system may allow therapist override of engagement-based decisions, enabling manual adjustment of task complexity when automated indicators do not reflect clinical judgment. Additionally, engagement indicators may be tracked longitudinally across therapy sessions, enabling analysis of engagement trends, identification of disengagement episodes, and prediction of therapy adherence.

In some embodiments, step 112 comprises computing an engagement score based on one or more engagement indicators extracted from a subject's speech response. The engagement score may reflect the subject's level of participation, attention, and responsiveness during therapy, and may be used to inform adaptive decisions in subsequent steps, including therapy task selection and delivery customization.

The engagement score may be computed using a weighted combination of multiple indicators, such as response latency, speech duration, prosodic variation, acoustic energy, and time-on-task. For example, a subject who responds within 1.2 seconds, speaks for 18 seconds, and exhibits high pitch variability may receive a higher engagement score than a subject with a 4.5-second delay, 6 seconds of speech, and flat prosody. Each indicator may be normalized to a common scale and assigned a configurable weight. In one example, speech duration may contribute 40% to the score, latency 25%, prosody 20%, and energy 15%, with weights adjusted based on therapist-defined priorities or subject-specific characteristics.

In further embodiments, therapists may configure weights to reflect clinical goals. For instance, a therapist working with a subject exhibiting apathy may prioritize vocal effort and speech duration, while another addressing affective flattening may emphasize prosodic variation and emotional tone. These weights may be manually set, selected from predefined templates, or dynamically adjusted based on session context or historical trends.

The engagement score may be computed in real time to support dynamic task adaptation and immediate feedback, or as part of a post-processing pipeline for retrospective analysis and therapist review. In some configurations, scores may be normalized across sessions to account for individual variability. For example, a subject with a baseline speech duration of 10 seconds may be scored differently than one with a baseline of 25 seconds, even if both speak for 15 seconds in a given session.

In multilingual therapy sessions, the system may compute engagement scores separately for each language segment. For example, if a subject speaks 22 seconds in Spanish with high prosodic variation and only 8 seconds in English with monotone delivery, the system may assign a higher engagement score to the Spanish segment and prioritize Spanish-language tasks in subsequent steps.

The engagement score may also be used to detect signs of fatigue, frustration, or boredom. For example, a drop in speech duration from 20 seconds to 6 seconds, combined with increased latency and reduced acoustic energy, may trigger a modality switch or task simplification. Conversely, consistently high scores may prompt the system to increase task complexity or introduce more challenging linguistic targets.

In some embodiments, engagement scores may be visualized through graphical interfaces such as heatmaps, trend lines, and session summaries. These visualizations may be accessible via a clinician dashboard and support manual override, annotation, and intervention. For example, a therapist may review engagement trends and override the system's task selection if the score does not align with clinical judgment.

Additionally, the engagement scoring process may support semi-supervised control, allowing therapists to adjust scoring parameters, override automated decisions, and provide feedback to the system. This hybrid approach ensures that therapy remains both adaptive and clinically grounded.

The method may include step 114, which comprises selecting a subsequent therapy task based on one or more factors including the subject's engagement score, error classification, therapist-defined constraints, session history, and comparative analysis of error matrices generated across multiple therapy sessions. The adaptive task selection process may support the system to personalize therapy delivery in real time, ensuring that each task is appropriately challenging, clinically relevant, and responsive to the subject's evolving cognitive and emotional state.

In step 114, the system may retrieve and compare error matrices from prior sessions to identify longitudinal trends, persistent error types, and areas of improvement or regression. This comparative analysis may be performed using statistical or machine learning models configured to detect patterns in error frequency, severity, and distribution across linguistic units and languages. For example, the system may compute delta matrices representing the change in error counts per phoneme or word between sessions, or may apply clustering algorithms to group similar error profiles over time.

To enable comparison of error matrices across therapy sessions where the patient produces different linguistic content, the system may implement statistical normalization and similarity techniques that account for variability in utterance length, vocabulary, and structure.

In some embodiments, the system may normalize error counts by converting them into relative frequencies. For example, if a patient produces 100 phonemes in session A and 60 in session B, and commits 10 and 6 phonemic substitutions respectively, the system may compute a normalized substitution rate of 0.10 for both sessions. This allows for direct comparison despite differences in speech length.

In further embodiments, the system may apply dimensionality reduction techniques such as principal component analysis (PCA) to compress high-dimensional error matrices into lower-dimensional vectors. These vectors may be compared using cosine similarity or Euclidean distance to assess whether the patient's error profile is stable or changing. For instance, a cosine similarity of 0.95 between sessions may indicate consistent error patterns, while a drop to 0.60 may signal a shift in performance.

To compare lexical errors across sessions with different words, the system may use semantic embeddings (e.g., Word2Vec or BERT) to map substituted or omitted words into a shared conceptual space. For example, if the patient substitutes “dog” with “cat” in one session and “car” with “truck” in another, the system may recognize both as within-category substitutions and treat them as semantically similar.

Structural errors may be compared using syntactic parse trees or dependency graphs. The system may compute tree edit distances to quantify syntactic deviation across sessions, enabling comparison even when sentence content differs.

In some embodiments, session-level error profiles may be constructed by aggregating normalized metrics across linguistic domains. These profiles may be compared using Mahalanobis distance or other statistical measures to detect trends in error severity or type. Temporal smoothing techniques such as moving averages may be applied to reduce volatility and highlight sustained changes. Additionally, Bayesian inference models may be used to estimate latent error tendencies, incorporating prior knowledge about aphasia type or language proficiency. These probabilistic profiles may be updated as new data becomes available and used to guide therapy planning and task selection.

To support this analysis and decision-making process, the system may employ one or more machine learning or artificial intelligence models. In some embodiments, a recurrent neural network (RNN), such as a long short-term memory (LSTM) model, may be used to model temporal dependencies in error patterns across sessions and predict future performance trajectories. In further embodiments, a reinforcement learning (RL) agent may be trained to select therapy tasks that maximize long-term engagement and error reduction, using reward signals derived from session outcomes and therapist feedback. In additional embodiments, a graph neural network (GNN) may be used to represent and analyze relationships between error types, linguistic domains, and task metadata, enabling the system to infer optimal task transitions based on structural similarities and historical outcomes.

The system may maintain a dynamic task repository comprising therapy prompts, exercises, and activities categorized by linguistic domain (e.g., phonology, morphology, syntax), modality (e.g., auditory, visual, multimodal), and complexity level (e.g., mild, moderate, severe aphasia). Each task may be associated with metadata including stimulus type (e.g., picture-based, narrative-based, question-based), response format (e.g., open-ended, yes/no, descriptive), personalization tags (e.g., sports, family, hobbies), and historical performance metrics (e.g., success rate, repetition frequency, engagement history). The system may use this metadata in combination with real-time performance indicators and matrix comparisons to select the next therapy task.

The selection process may incorporate multiple inputs, including the engagement score computed in step 112, the error classification from step 108, therapist-defined priorities or constraints (e.g., target language, therapy goals, prohibited task types), historical performance data (e.g., prior errors, engagement trends, task repetition), and session context (e.g., elapsed time, fatigue indicators, modality balance). In some embodiments, the system may apply a decision model that balances engagement and error severity while incorporating matrix-based insights. For instance, if a subject exhibits high engagement but persistent phonological errors across sessions, the system may select a task that reinforces phonological targets with increased repetition or multimodal support. Conversely, if engagement is low and error matrices indicate improvement, the system may introduce novel content or switch modalities to re-engage the subject.

In further examples, the system may model a subject's learning curve by comparing current performance metrics (e.g., speech rate, accuracy, latency) and error matrix deltas to historical baselines. If the subject demonstrates consistent improvement, the system may incrementally increase task complexity. If performance declines or engagement drops, the system may reduce complexity or switch to a different modality. For example, a subject struggling with verbal prompts may be presented with image-based tasks that elicit descriptive responses, selected based on prior success rates and error reduction patterns.

In some examples, the system may operate in autonomous or clinician-guided modes. In autonomous mode, task selection is performed algorithmically based on real-time data and matrix comparisons. In clinician-guided mode, the system may present a ranked list of candidate tasks for therapist review and approval. Therapists may annotate tasks, override selections, or define custom rules for task progression. This hybrid approach allows the system to adapt dynamically while preserving clinician oversight.

The adaptive task selection process may be visualized through a clinician dashboard, which may display task history, engagement trends, error distributions, matrix comparisons, and rationale for each selection. These visualizations may support retrospective analysis, session planning, and documentation for clinical reporting. In some configurations, the dashboard may include interactive controls for modifying task parameters, filtering task types, or previewing upcoming prompts.

In some embodiments, the system may include safeguards to prevent task repetition, overexposure to specific modalities, or excessive difficulty escalation. For example, the system may track task frequency and enforce minimum intervals between repetitions or may limit the number of consecutive tasks in a single modality. These safeguards help maintain therapeutic variety and prevent fatigue or frustration. Additionally, fallback strategies may be employed when engagement drops or error rates spike, such as switching to gamified tasks, introducing familiar content, or reducing prompt complexity.

The process may include step 116, which comprises presenting the selected therapy task to the subject in a manner that is linguistically appropriate, cognitively accessible, and responsive to the subject's engagement level and error profile. Task presentation may involve rendering the selected prompt or activity using one or more modalities, including auditory, visual, textual, or multimodal formats, and may be adapted in real time based on subject-specific parameters and session context.

In some embodiments, the system may present the therapy task using a graphical user interface (GUI) configured to display visual stimuli (e.g., images, symbols, written text), play audio prompts (e.g., synthesized or recorded speech), and capture subject responses via microphone, touchscreen, or other input devices. The GUI may be designed to minimize cognitive load and maximize clarity, using high-contrast visuals, simplified layouts, and intuitive navigation elements. For example, a picture-naming task may display a single image centered on the screen with a clear audio prompt and a visual cue indicating when to respond.

The modality of task presentation may be selected based on the subject's language profile, engagement score, and therapist-defined preferences. For instance, a subject with visual processing deficits may receive auditory-only prompts, while a subject with auditory comprehension challenges may be presented with text and image-based stimuli. In further examples, the system may alternate modalities across tasks to maintain engagement and support multimodal learning. For example, a subject may receive a spoken prompt followed by a visual reinforcement or may be asked to match written words to corresponding images.

In multilingual therapy sessions, the system may present tasks in one or more target languages, with language selection determined by therapist input, engagement metrics, or session goals. The system may support seamless switching between languages, allowing the subject to receive prompts in Spanish, English, or other supported languages without requiring manual reconfiguration. In some embodiments, the system may present bilingual prompts, such as a Spanish-language question followed by an English-language repetition, to support cross-linguistic generalization and code-switching practice.

The timing and pacing of task presentation may be dynamically adjusted based on the subject's response latency, speech duration, and engagement indicators. For example, if a subject consistently responds slowly, the system may increase the response window or introduce pacing cues. If a subject exhibits signs of fatigue or disengagement, the system may shorten task duration, simplify instructions, or insert a break prompt. These adjustments may be made automatically or in response to therapist override.

In some configurations, the system may include interactive elements that guide the subject through the task. For example, a visual progress bar may indicate task completion status, while animated cues may signal when to begin speaking or when a response has been registered. Feedback mechanisms may be embedded within the task presentation interface, allowing the subject to receive immediate confirmation, correction, or encouragement based on their response. These mechanisms are further described in step 118.

In further embodiments, the system may support personalized task presentation by incorporating subject-specific preferences, such as preferred colors, themes, or content categories. For example, a subject who enjoys sports may receive prompts featuring sports-related vocabulary or imagery. These preferences may be configured by the therapist or learned over time based on engagement patterns and response accuracy.

The task presentation process may be logged for clinical review, including metadata such as task type, modality, language, presentation timestamp, and subject response characteristics. This data may be used to generate session summaries, track progress, and inform future task selection. In some embodiments, the system may allow therapists to replay task presentations, annotate session recordings, or export task logs for documentation and analysis.

It will be appreciated that the task presentation techniques described herein may be implemented in various configurations, and that modifications may be made without departing from the scope of the present disclosure.

The process may include step 118, which comprises capturing the subject's spoken response to the presented therapy task and updating the subject's error profile based on analysis of the newly acquired speech data. This step enables the system to continuously refine its understanding of the subject's speech production capabilities, monitor progress across sessions, and inform subsequent therapy decisions.

In some embodiments, the subject's response may be captured via microphone input configured to record speech during or immediately following task presentation. The system may apply voice activity detection (VAD) to identify the onset and offset of speech, segment the audio stream into utterance-level units, and remove non-speech intervals or background noise. The segmented speech may be processed using automatic speech recognition (ASR) models adapted for disordered speech, including models trained on aphasic speech corpora or fine-tuned using subject-specific data. In multilingual therapy sessions, the system may apply language-specific ASR pipelines to ensure accurate transcription and error localization across languages.

Once the response is transcribed, the system may perform error analysis to identify deviations from expected linguistic targets. This may include phonological errors (e.g., substitutions, omissions, distortions), morphological and syntactic errors (e.g., incorrect verb inflections, word order violations), and semantic errors (e.g., off-topic responses, circumlocutions). The system may compare the subject's utterance to a reference prompt or expected response using alignment scoring, edit distance metrics, or rule-based matching. In some configurations, the system may detect disfluencies such as hesitations, repetitions, and self-corrections, which may be indicative of underlying speech planning or motor execution difficulties.

In further embodiments, the system may update the subject's error profile by incorporating the newly detected errors into a cumulative record. The error profile may include error frequency, error type distribution, and temporal patterns across sessions. For example, the system may track whether a subject consistently omits initial consonants in English but not in Spanish, or whether syntactic errors decrease over time in response to targeted feedback. This evolving error profile may be used to adjust task selection (step 114), prioritize feedback targets (step 120), and support therapist review and intervention.

The system may also capture non-verbal indicators associated with the response, such as latency to initiate speech, duration of utterance, and vocal effort. These features may be extracted from the audio signal and used to supplement the error analysis. For example, a short, low-energy utterance with long latency may suggest reduced engagement or motor fatigue, even if the linguistic content is accurate. In some embodiments, the system may fuse these acoustic features with engagement indicators extracted in step 110 to provide a more comprehensive assessment of the subject's performance.

In some configurations, the system may support therapist annotation of captured responses. Therapists may review audio recordings, transcriptions, and error classifications, and may add manual corrections, comments, or override flags. These annotations may be stored alongside automated analysis results and used to refine future error detection models or guide semi-supervised learning processes. For example, a therapist may flag a response as contextually appropriate despite a lexical substitution, prompting the system to adjust its semantic error thresholds.

The response capture and error update process may be logged for clinical documentation, including metadata such as task identifier, response timestamp, language, modality, and error classification results. This data may be used to generate session summaries, visualize progress over time, and support outcome reporting. In some embodiments, the system may present error trends using graphical interfaces such as annotated transcripts, error heatmaps, or longitudinal charts accessible via a clinician dashboard.

The process may include step 120, which comprises updating the decision model used by the therapy system to guide future task selection, feedback delivery, and engagement management. The decision model may be configured to integrate multiple sources of input-including engagement scores, error classifications, therapist-defined constraints, and historical performance data—and may be continuously refined based on the subject's evolving speech profile and therapy outcomes.

In some embodiments, the decision model may be implemented as a rule-based engine, a weighted scoring system, or a machine learning model trained on therapy session data. The model may maintain internal representations of the subject's current linguistic capabilities, engagement patterns, and error tendencies, and may use these representations to predict the optimal next step in the therapy sequence. For example, the model may determine whether to repeat a task, escalate difficulty, switch modalities, or introduce a new linguistic target based on recent performance and engagement indicators.

The update process may be triggered following each captured response (step 118) and may involve recalculating internal metrics such as error severity scores, engagement trend slopes, and task success probabilities. These metrics may be used to adjust the weighting of decision factors within the model. For instance, if a subject's engagement score has declined over several tasks, the model may increase the influence of engagement-related features in task selection. Conversely, if error rates in a specific domain (e.g., phonology) remain high despite repeated exposure, the model may prioritize error correction over novelty or engagement.

In further embodiments, the decision model may incorporate therapist input as a supervisory signal. Therapists may define constraints (e.g., avoid certain task types, emphasize specific linguistic domains), override model decisions, or annotate session outcomes. These inputs may be used to adjust model parameters, retrain adaptive components, or enforce rule-based overrides. For example, a therapist may specify that semantic errors should be deprioritized for a subject with motor speech deficits, prompting the model to reduce the weight of semantic error metrics in future decisions.

The model may also be configured to support multilingual therapy by maintaining separate decision pathways for each language. Engagement scores, error profiles, and task histories may be tracked independently for each language, allowing the model to adapt its behavior based on language-specific performance. For example, if a subject demonstrates high engagement and low error rates in Spanish but struggles with English prompts, the model may increase Spanish-language task frequency or simplify English-language tasks until performance improves.

In some configurations, the decision model may be implemented as a hybrid system combining deterministic logic with probabilistic inference. For example, the model may use a decision tree to enforce therapist-defined rules, while applying a Bayesian network or neural network to estimate task success likelihoods based on historical data. This hybrid approach enables both transparency and adaptability, allowing clinicians to understand and influence the model's behavior while benefiting from data-driven optimization.

The updated decision model may be stored in association with session metadata, including timestamps, task identifiers, and subject-specific parameters. These updates may be logged for clinical review, enabling therapists to audit model decisions, visualize decision pathways, and assess the impact of model changes over time. In some embodiments, the system may provide a dashboard interface that displays model state, decision rationale, and configurable parameters, allowing therapists to interact with and refine the model as therapy progresses.

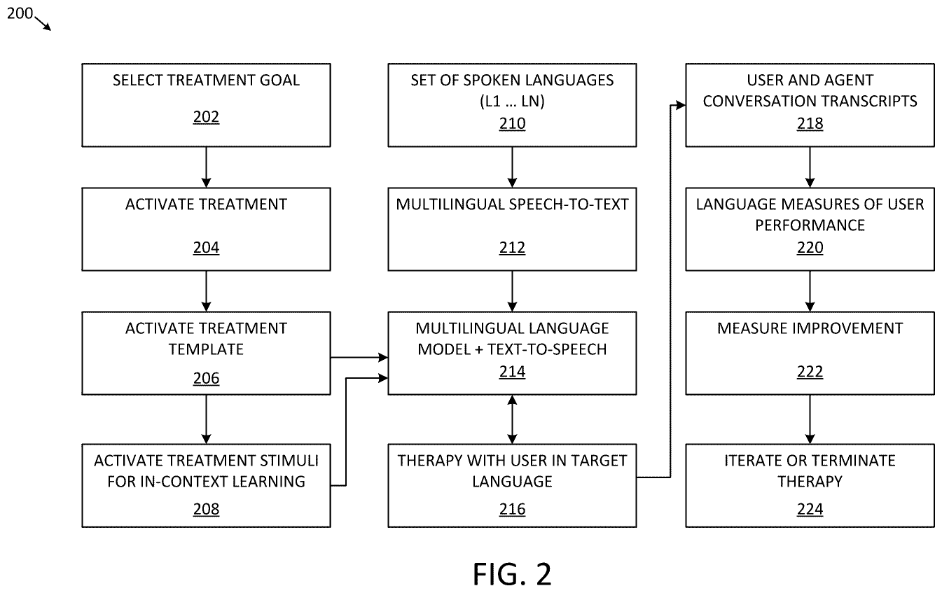

FIG. 2 illustrates a method 200 for delivering adaptive multilingual language therapy using a computer-implemented artificial intelligence (AI) agent. In some embodiments, the method 200 may be executed by a system comprising a plurality of software modules configured to operate in coordination to deliver personalized speech therapy across multiple languages. The system may include, but is not limited to, a user profile manager, a multilingual speech pipeline, a language identification module, a speech recognition engine, an error extraction engine, a speech and language error matrix generator, an engagement signal processor, an adaptive task selector, a prompt generator, a multilingual text-to-speech (TTS) engine, and a clinician dashboard interface.

In some aspects, the method 200 begins at block 202 with profile and goal initialization. The system may retrieve a user profile comprising demographic information (e.g., age), linguistic background (e.g., native and secondary languages), and clinical diagnosis (e.g., Broca's aphasia, Wernicke's aphasia, mixed aphasia). The system may receive a treatment goal either from a clinician or through a user interface. In some implementations, treatment goals may include improving phonemic articulation, enhancing semantic fluency, or increasing pragmatic competence. The system may filter a multilingual therapy task library to produce a goal-specific task set, wherein the task library comprises structured therapy exercises indexed by language, error type, and therapeutic objective. For example, a user with nonfluent aphasia may be assigned sentence construction tasks in Spanish, while a user with fluent aphasia may receive semantic elaboration tasks in Hindi.

At block 204, the system activates the treatment. This includes initializing the therapy engine with the selected goal and preparing the system to deliver therapy prompts. In some examples, the system may load goal-specific templates and configure the multilingual speech pipeline. For instance, if the goal is phonemic correction in Spanish, the system may load Spanish phoneme discrimination tasks and activate Spanish speech recognition. The system may also prompt the user to confirm the target language, thereby ensuring that all subsequent operations are aligned with the selected therapeutic objective. In some implementations, the system may operate as a mobile or desktop application and may support both clinician-guided and self-guided therapy workflows.

At block 206, the system activates a treatment template. The treatment template defines the structure of the therapy session, including the number of conversational turns, types of prompts, and feedback mechanisms. Templates may be selected based on the treatment goal and user profile. For example, a semantic elaboration template may include picture description tasks followed by elaboration prompts, while a pragmatic training template may include conversational turn-taking exercises. In further aspects, templates may be modified in real time based on engagement scores or clinician input. In some implementations, the system supports dynamic template switching, allowing therapy to evolve in response to user performance and engagement fluctuations.

At block 208, the system activates treatment stimuli for in-context learning. The stimuli may include images, topics, or scripted statements designed to elicit specific linguistic responses. These stimuli may be paired with prompt templates that guide the user toward elaborated or corrected responses. For example, a picture of a person cooking may be used to elicit subject-verb-object constructions, with the agent providing semantic or phonemic cues. In some embodiments, the system supports both static and dynamic stimuli, enabling real-time adaptation based on user performance. Prompting techniques such as chain-of-thought (CoT) and zero-shot prompting may be used to guide the language model in generating therapeutic responses. In certain examples, the system may use simulated aphasic speech to train the model to recognize and respond to common error patterns across languages.

At block 210, the system identifies the set of spoken languages (L1 . . . LN) supported by the system. The system may prompt the user to select a target language or may automatically detect the spoken language using multilingual speech identification algorithms. In some implementations, the system supports code-switching and can segment input across multiple languages. For example, a bilingual user may begin therapy in English and switch to Hindi, with the system adapting prompts and feedback accordingly. The system may support over 40 languages and may track errors across them in a unified framework. In further aspects, language identification may be performed at the utterance or phrase level, enabling fine-grained adaptation of therapy prompts and feedback.

At block 212, the system performs multilingual speech-to-text conversion. The system captures audio input and applies language-specific speech recognition models. In some embodiments, error-tolerant models trained on aphasic speech are used to improve transcription accuracy. For example, the system may simulate phonemic substitutions and omissions to fine-tune recognition models. The transcribed text is aligned with expected outputs to identify deviations, which populate a Speech and Language Error Matrix. In some implementations, this matrix may be structured as a grid where columns represent languages and rows represent error types (e.g., phonemic substitutions, lexical omissions, syntactic distortions). Each user may have a personalized matrix, which may be aphasia-type specific and may evolve over time. The matrix may support multilingual error tracking and may inform therapy adaptation across sessions.

At block 214, the system applies a multilingual language model and text-to-speech engine. The transcribed input is processed by a language model that classifies errors and generates therapeutic responses, including corrective feedback, elaboration prompts, or reinforcement messages. The system then converts the generated text into speech using a language-specific text-to-speech engine. In some examples, the speech output may be generated in an imitation of the user's voice. In further aspects, the system may use in-context learning and simulation pipelines to train models on aphasic speech across languages. The language model may also incorporate engagement signals to modulate the tone, complexity, and pacing of responses.

At block 216, the system conducts therapy with the user in the target language. The AI agent engages the user in structured conversation, guided by the treatment template and stimuli. Each conversational turn is logged, and transcripts are stored for analysis. Therapy sessions may include elaboration chains, corrective feedback, and reinforcement, tailored to the user's linguistic profile and error history. In some implementations, the system supports approximately 8-10 conversational turns per stimulus, with flexibility to extend or shorten sessions. For example, the system may dynamically adjust the number of turns based on engagement scores and task completion rates.

At block 218, the system generates conversation transcripts and computes language measures of user performance. The system computes metrics such as Correct Information Units (CIUs), response latency, speech duration, and prosodic features. These metrics are used to assess progress and update the error matrix. For example, a decrease in phonemic substitutions may indicate improved articulation, while increased CIUs may suggest enhanced content generation. The system also evaluates coherence and fluency to ensure logical flow and relevance of responses. In some implementations, engagement metrics may be computed using a weighted function that integrates latency, duration, and procedural variation, and may be used to adjust task difficulty or delivery style.

At block 222, the system measures improvement based on accumulated performance data. The system compares current metrics with baseline values to determine progress toward the treatment goal. In some embodiments, improvement may be quantified using weighted scores that integrate error reduction, engagement, and task completion rates. Progress may be visualized on a dashboard for clinician review. For example, if a user consistently performs well on phonemic tasks but struggles with syntactic constructions, the clinician may adjust the therapy focus accordingly. In further aspects, the system may recommend therapy adjustments based on persistent error types or declining engagement scores.

At block 224, the system determines whether to iterate or terminate therapy. Based on improvement metrics, engagement scores, and clinician input, the system decides whether to continue with the current treatment, modify the goal, or conclude the session. The decision policy may be automated, therapist-driven, or hybrid. For example, if a user has mastered phoneme articulation, the system may recommend transitioning to pragmatic skills training. In some implementations, the system supports multilingual therapy, personalized error tracking, and adaptive task selection, enabling efficient and responsive treatment across diverse linguistic and clinical profiles.

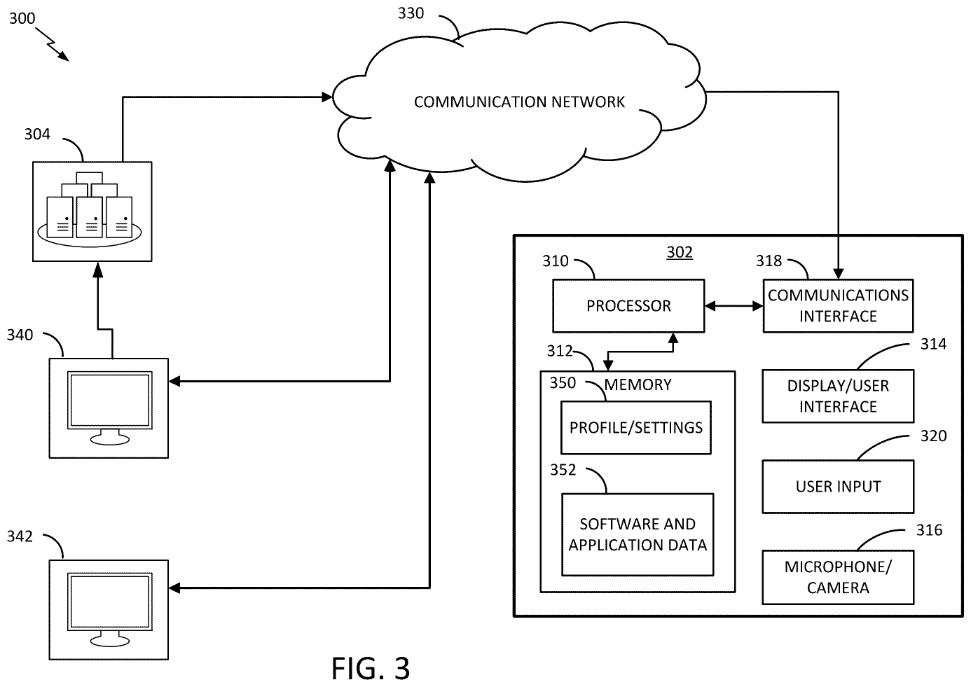

FIG. 3 is a conceptual block diagram illustrating a system 300 for implementing personalized feedback and adaptive prompt complexity in multilingual speech therapy. In one aspect, system 300 may represent a modular architecture for delivering, analyzing, and refining speech therapy sessions tailored to individual patient needs. In another aspect, system 300 may be deployed as a distributed platform across mobile devices, cloud-based infrastructure, and clinician workstations to support real-time processing, longitudinal tracking, and multilingual modeling of aphasic speech.

As shown, system 300 includes a mobile device 302, which may be a smartphone, tablet, or dedicated speech therapy device. Mobile device 302 may execute a therapy application configured to present scripted prompts, record patient responses, apply recursive self-feedback, generate corrected speech feedback, and log session metrics. In some embodiments, mobile device 302 may also generate and update a multilingual aphasic speech matrix, which stores individualized error types (e.g., phonemic, semantic, syntactic) across multiple languages. This matrix enables the system to identify language-specific deficits and tailor therapy tasks accordingly.

Mobile device 302 may include subcomponents such as a processor 310, which may be a general-purpose CPU, GPU, or specialized hardware optimized for natural language processing and speech analytics. In some embodiments, processor 310 may execute alignment scoring and attention weighting mechanisms to determine the relevance of different speech features or error types. These mechanisms may compute dependencies between speech vectors using softmax-normalized attention scores, which guide the selection and prioritization of therapy targets. Additionally, processor 310 may support real-time engagement scoring based on multimodal indicators such as response latency, speech duration, prosodic variation, and acoustic energy.

A memory 312, which may include volatile (RAM) and non-volatile (flash, SSD) storage, may store patient profiles, therapy parameters, and application data. In further examples, memory 312 may also store longitudinal engagement metrics, updated error matrices, and personalized voice models for text-to-speech synthesis. These data structures allow the system to adaptively select tasks based on both performance and engagement trends, supporting clinician oversight and intervention. The system may also store session-level metadata including timestamps, modality types, and error classifications to support retrospective analysis and dashboard visualization.

Additional components of mobile device 302 may include a display 314 for presenting visual prompts and feedback, a microphone 316 for capturing speech input, a user input interface 318 (e.g., touchscreen, keyboard, or voice command system), and a communications interface 320 supporting Wi-Fi, Bluetooth, or cellular connectivity for data exchange with server 304. In some embodiments, display 314 may present corrected speech feedback in the patient's own voice, generated using personalized synthesis models stored in memory 312 or accessed via server 304. User input interface 318 may allow patients to select among generated responses or therapy tasks thereby supporting autonomy and engagement for patients with severe expressive deficits.

System 300 further includes a server 304, which may manage therapy prescriptions, perform speech analysis, and generate adaptive feedback. Server 304 may include multiple processing cores, a storage 322 for maintaining therapy logs, historical speech data, multilingual speech matrices, and clinician annotations, and one or more network interfaces 324 for secure communication. In some embodiments, server 304 may integrate with electronic medical record (EMR) systems to provide clinicians with access to patient progress and therapy settings. Server 304 may also host a provider portal for remote monitoring, configuration, and review of therapy outcomes.

In alternative embodiments, some or all of the processing tasks described above may be performed server-side. For example, speech recognition, error classification, engagement scoring, and therapy task selection may be offloaded to server 304 to reduce computational load on mobile device 302. This configuration may be particularly advantageous for low-power devices or deployments in resource-constrained environments. In such embodiments, mobile device 302 may function primarily as a data capture and display interface, while server 304 performs the core analytics and decision-making functions.

In further embodiments, system 300 may be deployed in a hybrid configuration, wherein initial speech processing and engagement scoring are performed locally on mobile device 302, while higher-order functions such as multilingual modeling, therapy adaptation, and clinician dashboard updates are executed server-side. This hybrid model allows for real-time responsiveness while leveraging centralized resources for complex computations and longitudinal data management.

Server 304 may execute services including pretrained language models, transformer-based speech correction models, and prompt generation agents. In some embodiments, server 304 may store patient-specific model instances or voice samples to enable personalized text-to-speech synthesis. Server 304 may also store and apply prompt-elaboration models to dynamically adjust prompt complexity based on patient performance trends. Additionally, server 304 may support cross-lingual processing capabilities, enabling the system to model aphasic speech in multiple languages and determine how performance in one language affects the other. The system may merge multilingual data into a unified matrix while preserving language-specific tracking.

A workstation 306 may be provided for clinicians to configure therapy plans and review patient data. Workstation 306 may include a graphical user interface (GUI) for accessing session logs, adherence metrics, and AI-generated insights. In some implementations, clinicians may manually override automated settings or fine-tune therapy prescriptions based on clinical judgment. The system may also allow therapist interventions that influence the adaptive decision policy, ensuring that therapy remains aligned with clinical goals.

A communication network 308 connects mobile device 302, server 304, and workstation 306. The network may include the Internet, cellular networks, or local area networks, and may support real-time synchronization of therapy data, secure transmission of patient records, and remote session scheduling. End-to-end encryption protocols may be employed to ensure compliance with data privacy regulations. In some embodiments, system 300 may further include cloud-based processing resources to support scalable deployment, intensive computation, and seamless device interoperability. These resources may enable advanced features such as phoneme-level error detection, semantic coherence analysis, and adaptive scheduling based on patient engagement patterns.

In yet another embodiment, system 300 may be deployed entirely within a cloud-based infrastructure, wherein mobile device 302 and workstation 306 serve as thin clients. In this configuration, all processing, storage, and decision-making functions are centralized within server 304 or associated cloud services. This model may facilitate large-scale deployment across clinical networks, support multi-user environments, and enable centralized updates to therapy algorithms and language models.

The system architecture described herein supports flexible deployment across a range of clinical, home-based, and teletherapy settings. By enabling both client-side and server-side processing, system 300 accommodates diverse hardware capabilities, network conditions, and therapeutic goals, thereby enhancing accessibility, scalability, and personalization in multilingual aphasia treatment.

The techniques, technologies, algorithms, and advantages described herein may be implemented in a variety of practical applications, which may serve to improve systems and methods used or performed by several different individuals, companies, and/or institutions involved in speech therapy, mHealth, aphasia treatment, cognitive therapy, and the like.

In one category of embodiments, systems and methods may be configured to function as a tool to improve the ability of healthcare providers to give tailored care to their patients in a prompt and efficient manner. Thus, such embodiments may involve provider portals that allow providers to adjust settings, monitor progress and adherence, and ensure that routine treatment is available to their patients outside of the clinic, via mobile, adaptive, and effective delivery approaches. These embodiments may include enriched features for allowing providers and patients to communicate and coordinate the delivery of speech therapy on an ongoing basis, such as private messaging, posting results and feedback, and coordinating adjustments to settings and analysis of trends and outliers.

Alternatively, or additionally, the systems and methods describe above may be embodied in a more user-driven implementation, that relies on automated logic and/or an AI agent to suggest prescription settings and updates based on user capability and progress. Thus, in such embodiments, a provider portal may not necessarily be utilized, and instead settings, feedback, and overall management and guidance of therapy may be performed according to prewritten logic.

Aphasia, affecting 30-40% of stroke survivors, is a language disorder characterized by fragmented speech and word retrieval errors that significantly impair quality of life. Current aphasia treatments, typically administered by speech-language pathologists (SLPs), are constrained by a shortage of multilingual professionals. This shortage leaves many persons with aphasia (PWA) without personalized care due to language barriers. To address this gap, the present study introduces the Multilingual AI-Agent for Language Therapy (MALT), a system that combines advanced multilingual speech technologies with a state-of-the-art large language model (LLM) to deliver Response Elaboration Training (RET) in over 40 widely spoken languages in the United States and globally. RET is an evidence-based treatment that helps PWA expand their responses through a chaining technique, offering corrective feedback and positive reinforcement. MALT automates and democratizes this process across various languages, though its effectiveness may depend on the prompting techniques used. This technology evaluates the impact of two prompting techniques—chain-of-thought (CoT) and zero-shot—on the performance of both MALT and its human users in English, Hindi, and Spanish.

Method: MALT was built using GPT-40 and integrated with external multilingual speech-to-text and text-to-speech systems. Two general prompt templates—CoT and zero-shot—were developed to guide the LLM in implementing RET across diverse languages and accommodating the distinctive features of multilingual aphasic speakers. Three participants—a certified SLP (English), a graduate student SLP (Spanish), and a non-SLP graduate student (Hindi)—were trained to simulate aphasic speech. Initially, they responded with minimal content and then elaborated their responses based on MALT's prompts. Each participant engaged in 8-10 conversational turns per stimulus with MALT via a desktop computer in a controlled setting. Four conditions were tested: CoT+pictures, CoT+topics, zero-shot+pictures, and zero-shot+topics. Each condition involved 10 stimuli, either pictures illustrating subject-verb-object relations or generic topics such as favorite sports. These conditions were later grouped into two categories: CoT versus zero-shot. Participants were given brief breaks between conditions to prevent fatigue. The study analyzed the number and proportion of Correct Information Units (CIUs)—contextually relevant words excluding fillers and repetitions—and evaluated the local and global coherence of MALT's prompts, assessing logical flow and relevance to the stimuli. These measures were selected for their clinical relevance.

Results The CoT prompting technique consistently generated more informative responses across all languages. In English, CoT conditions yielded a higher mean CIU per utterance (3.04; 76% CIUs) compared to zero-shot (2.63; 73% CIUs). Similar results were observed in Hindi (CoT: 2.10; 76% CIUs vs. zero-shot: 2.10; 75% CIUs) and Spanish (CoT: 3.84; 99% CIUs vs. zero-shot: 3.70; 84% CIUs). Global and local coherence scores were high across all conditions and languages, indicating that MALT's prompts maintained logical flow and contextual relevance regardless of the prompting technique.

The following examples describe aspects of the disclosed technology:

Example 1: A method for treating a language disorder in a patient, the method comprising: receiving therapist input indicating a speech target and an engagement indicator priority; capturing audio comprising a speech response from the patient in response to a therapy prompt; identifying a language of the speech response using a multilingual language identification model; analyzing the speech response using a language-specific recognition model to extract speech features and classify errors across a plurality of error dimensions, wherein each error dimension corresponds to a distinct linguistic or acoustic feature; extracting engagement indicators from the speech response; computing an engagement score based on the extracted engagement indicators and the engagement indicator priority; applying a decision model to select a therapy task based at least on the error classifications, the engagement score, and the speech target; presenting the selected therapy task to the patient; capturing audio comprising a subsequent speech response from the patient and updating the error classifications based on the subsequent speech response; and updating the decision model in response to therapist input and the revised error classifications.

Example 2: The method of example 1, further comprising: generating a speech and language error matrix that maps the classified errors across the plurality of error dimensions to corresponding time-aligned segments of the speech response, wherein the error matrix comprises a multi-dimensional representation associating phonemic, lexical, and syntactic error types with temporal and linguistic metadata; wherein the decision model comprises the speech and language error matrix and is configured to select therapy tasks based on error frequency and persistence as represented in the matrix; and wherein the step of updating the error classifications based on the subsequent speech response comprises updating the speech and language error matrix to reflect longitudinal changes in error patterns.

Example 3: The method of any of examples 1-2, wherein the multilingual language identification model is configured to detect a plurality of spoken languages within a single speech response; wherein the language-specific recognition model comprises a plurality of language-adapted modules, each configured to extract speech features and classify errors in accordance with the phonological, lexical, and syntactic rules of a respective language; and wherein the speech and language error matrix comprises a plurality of language-specific submatrices, each corresponding to a detected language and configured to store error classifications in that language, wherein the decision model accesses the submatrices to assess error frequency and persistence across multiple languages.

Example 4: The method of any of examples 1-3, wherein the engagement score is computed based on a plurality of engagement indicators extracted from the speech response, the engagement indicators comprising at least one of response latency, speech duration, speech rate, and acoustic energy; the engagement score is normalized across therapy sessions to account for individual variability in baseline speech characteristics, wherein the normalization comprises computing a session-specific baseline and adjusting the raw engagement indicators accordingly; the decision model is configured to incorporate the normalized engagement score as a weighting factor in therapy task selection, such that tasks associated with higher engagement levels are prioritized.

Example 5: The method of any of examples 1-4, wherein the therapy task comprises a multilingual speech repetition exercise tailored to the patient's dominant language and error profile.

Example 6: The method of any of examples 1-5, wherein the decision model incorporates therapist feedback to dynamically adjust error weighting across sessions.

Example 7: The method of any of examples 1-6, wherein the therapy task is selected based on a multilingual speech and language error matrix that tracks error types across multiple languages for a single patient, and wherein the system dynamically adapts the therapy task to the patient's current language context.

Example 8: A system for treating a language disorder in a patient, comprising a processor and a non-transitory computer-readable medium storing instructions that, when executed by the processor, cause the system to: receive therapist input indicating a speech target and an engagement indicator priority; capture audio comprising a speech response from the patient in response to a therapy prompt; identify a language of the speech response using a multilingual language identification model; analyze the speech response using a language-specific recognition model to extract speech features and classify errors across a plurality of error dimensions, wherein each error dimension corresponds to a distinct linguistic or acoustic feature; extract engagement indicators from the speech response; compute an engagement score based on the extracted engagement indicators and the engagement indicator priority; apply a decision model to select a therapy task based at least on the error classifications, the engagement score, and the speech target; present the selected therapy task to the patient; capture audio comprising a subsequent speech response from the patient and update the error classifications based on the subsequent speech response; and update the decision model in response to therapist input and the revised error classifications.

Example 9: The system of example 8, wherein the instructions further cause the processor to: generate a speech and language error matrix that maps the classified errors across the plurality of error dimensions to corresponding time-aligned segments of the speech response, wherein the error matrix comprises a multi-dimensional representation associating phonemic, lexical, and syntactic error types with temporal and linguistic metadata; select therapy tasks based on error frequency and persistence as represented in the matrix; and update the speech and language error matrix to reflect longitudinal changes in error patterns.

Example 10: The system of any of examples 8-9, wherein the multilingual language identification model is configured to detect a plurality of spoken languages within a single speech response; wherein the language-specific recognition model comprises a plurality of language-adapted modules, each configured to extract speech features and classify errors in accordance with the phonological, lexical, and syntactic rules of a respective language; and wherein the speech and language error matrix comprises a plurality of language-specific submatrices, each corresponding to a detected language and configured to store error classifications in that language, wherein the decision model accesses the submatrices to assess error frequency and persistence across multiple languages.

Example 11: The system of any of examples 8-10, wherein the instructions further cause the processor to: compute the engagement score based on a plurality of engagement indicators extracted from the speech response, the engagement indicators comprising at least one of response latency, speech duration, speech rate, and acoustic energy; normalize the engagement score across therapy sessions by computing a session-specific baseline and adjusting the raw engagement indicators accordingly; and incorporate the normalized engagement score as a weighting factor in therapy task selection, such that tasks associated with higher engagement levels are prioritized.

Example 12: The system of any of examples 8-11, wherein the therapy task comprises a multilingual speech repetition exercise tailored to the patient's dominant language and error profile.

Example 13: The system of any of examples 8-12, wherein the decision model incorporates therapist feedback to dynamically adjust error weighting across sessions.

Example 14: The system of any of examples 8-13, wherein the therapy task is selected based on a multilingual speech and language error matrix that tracks error types across multiple languages for a single patient, and wherein the system dynamically adapts the therapy task to the patient's current language context.

Example 15: A non-transitory computer-readable medium storing instructions that, when executed by a processor, cause the processor to: receive therapist input indicating a speech target and an engagement indicator priority; capture audio comprising a speech response from the patient in response to a therapy prompt; identify a language of the speech response using a multilingual language identification model; analyze the speech response using a language-specific recognition model to extract speech features and classify errors across a plurality of error dimensions, wherein each error dimension corresponds to a distinct linguistic or acoustic feature; extract engagement indicators from the speech response; compute an engagement score based on the extracted engagement indicators and the engagement indicator priority; apply a decision model to select a therapy task based at least on the error classifications, the engagement score, and the speech target; present the selected therapy task to the patient; capture audio comprising a subsequent speech response from the patient and update the error classifications based on the subsequent speech response; and update the decision model in response to therapist input and the revised error classifications.

Example 16: The medium of example 15, wherein the instructions further cause the processor to: generate a speech and language error matrix that maps the classified errors across the plurality of error dimensions to corresponding time-aligned segments of the speech response, wherein the error matrix comprises a multi-dimensional representation associating phonemic, lexical, and syntactic error types with temporal and linguistic metadata; select therapy tasks based on error frequency and persistence as represented in the matrix; and update the speech and language error matrix to reflect longitudinal changes in error patterns.

Example 17: The medium of any of examples 15-16, wherein the multilingual language identification model is configured to detect a plurality of spoken languages within a single speech response; wherein the language-specific recognition model comprises a plurality of language-adapted modules, each configured to extract speech features and classify errors in accordance with the phonological, lexical, and syntactic rules of a respective language; and wherein the speech and language error matrix comprises a plurality of language-specific submatrices, each corresponding to a detected language and configured to store error classifications in that language, wherein the decision model accesses the submatrices to assess error frequency and persistence across multiple languages.

Example 18: The medium of any of examples 15-17, wherein the instructions further cause the processor to: compute the engagement score based on a plurality of engagement indicators extracted from the speech response, the engagement indicators comprising at least one of response latency, speech duration, speech rate, and acoustic energy; normalize the engagement score across therapy sessions by computing a session-specific baseline and adjusting the raw engagement indicators accordingly; and incorporate the normalized engagement score as a weighting factor in therapy task selection, such that tasks associated with higher engagement levels are prioritized.

Example 19: The medium of any of examples 15-18, wherein the therapy task comprises a multilingual speech repetition exercise tailored to the patient's dominant language and error profile.

Example 20: The medium of any of examples 15-19, wherein the decision model incorporates therapist feedback to dynamically adjust error weighting across sessions.

Example 21: The medium of any of examples 15-20, wherein the therapy task is selected based on a multilingual speech and language error matrix that tracks error types across multiple languages for a single patient, and wherein the system dynamically adapts the therapy task to the patient's current language context.

In the foregoing specification, implementations of the disclosure have been described with reference to specific example implementations thereof. It will be evident that various modifications may be made thereto without departing from the broader spirit and scope of implementations of the disclosures as set forth in the following claims. The specification and drawings are, accordingly, to be regarding in an illustrative sense rather than a restrictive sense.

What is claimed is:

1. A method for treating a language disorder in a patient, the method comprising:
receiving therapist input indicating a speech target and an engagement indicator priority;
capturing audio comprising a speech response from the patient in response to a therapy prompt;
identifying a language of the speech response using a multilingual language identification model;
analyzing the speech response using a language-specific recognition model to extract speech features and classify errors across a plurality of error dimensions, wherein each error dimension corresponds to a distinct linguistic or acoustic feature;
extracting engagement indicators from the speech response;
computing an engagement score based on the extracted engagement indicators and the engagement indicator priority;
applying a decision model to select a therapy task based at least on the error classifications, the engagement score, and the speech target;
presenting the selected therapy task to the patient;
capturing audio comprising a subsequent speech response from the patient and updating the error classifications based on the subsequent speech response; and
updating the decision model in response to therapist input and the revised error classifications.

2. The method of claim 1, further comprising:
generating a speech and language error matrix that maps the classified errors across the plurality of error dimensions to corresponding time-aligned segments of the speech response, wherein the error matrix comprises a multi-dimensional representation associating phonemic, lexical, and syntactic error types with temporal and linguistic metadata;
wherein the decision model comprises the speech and language error matrix and is configured to select therapy tasks based on error frequency and persistence as represented in the matrix; and
wherein the step of updating the error classifications based on the subsequent speech response comprises updating the speech and language error matrix to reflect longitudinal changes in error patterns.

3. The method of claim 2, wherein:
the multilingual language identification model is configured to detect a plurality of spoken languages within a single speech response;
the language-specific recognition model comprises a plurality of language-adapted modules, each configured to extract speech features and classify errors in accordance with the phonological, lexical, and syntactic rules of a respective language; and
the speech and language error matrix comprises a plurality of language-specific submatrices, each corresponding to a detected language and configured to store error classifications in that language, wherein the decision model accesses the submatrices to assess error frequency and persistence across multiple languages.

4. The method of claim 1, wherein:
the engagement score is computed based on a plurality of engagement indicators extracted from the speech response, the engagement indicators comprising at least one of response latency, speech duration, speech rate, and acoustic energy;
the engagement score is normalized across therapy sessions to account for individual variability in baseline speech characteristics, wherein the normalization comprises computing a session-specific baseline and adjusting the raw engagement indicators accordingly;
the decision model is configured to incorporate the normalized engagement score as a weighting factor in therapy task selection, such that tasks associated with higher engagement levels are prioritized.
